(19) United States
(12) Patent Application Publication
(10) Pub. No.: US 2026/0089517 A1
(43) Pub. Date: Mar. 26, 2026

(54) MODEL MONITORING USING INPUT SAMPLES

(71) Applicant: QUALCOMM Incorporated, San Diego, CA (US)

(72) Inventors: Chenxi HAO, Beijing (CN); Taesang YOO, San Diego, CA (US); Jay Kumar SUNDARARAJAN, San Diego, CA (US); June NAMGOONG, San Diego, CA (US); Runxin WANG, San Diego, CA (US); Yu ZHANG, San Diego, CA (US)

(21) Appl. No.: 19/112,854

(22) PCT Filed: Nov. 7, 2022
(86) PCT No.: PCT/CN2022/130219

§ 371 Date: Mar. 18, 2025

(51) Int. Cl. H04W 24/02; H04L 41/16

(52) U.S. Cl. CPC H04W 24/02; H04L 41/16

(57) ABSTRACT

Various aspects of the present disclosure generally relate to wireless communication. In some aspects, a user equipment (UE) may determine a metric based at least in part on an input sample and training samples, the training samples being associated with an artificial intelligence or machine learning (AI/ML) model, and the metric being determined during a monitoring of the AI/ML model. The UE may compare the metric to a threshold. The UE may determine a decision based at least in part on the comparison of the metric to the threshold. The UE may transmit, to a network node, an indication of the metric and the decision. Numerous other aspects are described.

### FIELD OF THE DISCLOSURE

Aspects of the present disclosure generally relate to wireless communication and to techniques and apparatuses for model monitoring using input samples.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: determine a metric based at least in part on an input sample and training samples, the training samples being associated with an artificial intelligence or machine learning (AI/ML) model, and the metric being determined during a monitoring of the AI/ML model; compare the metric to a threshold; determine a decision based at least in part on the comparison of the metric to the threshold; and transmit, to a network node, an indication of the metric and the decision.

In some implementations, an apparatus for wireless communication at a network node includes a memory and one or more processors, coupled to the memory, configured to: receive, from a UE, an indication of a metric and a decision made by the UE, the metric being based at least in part on an input sample and training samples, the training samples being associated with an AI/ML model, the metric being associated with a monitoring of the AI/ML model, and the decision being based at least in part on a comparison of the metric and a threshold.

In some implementations, a method of wireless communication performed by a UE includes determining a metric based at least in part on an input sample and training samples, the training samples being associated with an AI/ML model, and the metric being determined during a monitoring of the AI/ML model; comparing the metric to a threshold; determining a decision based at least in part on the comparing of the metric to the threshold; and transmitting, to a network node, an indication of the metric and the decision.

In some implementations, a method of wireless communication performed by a network node includes receiving, from a UE, an indication of a metric and a decision made by the UE, the metric being based at least in part on an input sample and training samples, the training samples being associated with an AI/ML model, the metric being associated with a monitoring of the AI/ML model, and the decision being based at least in part on the comparison of the metric and a threshold.

In some implementations, a non-transitory computer-readable medium storing a set of instructions for wireless communication includes one or more instructions that, when executed by one or more processors of a UE, cause the UE to: determine a metric based at least in part on an input sample and training samples, the training samples being associated with an AI/ML model, and the metric being determined during a monitoring of the AI/ML model; compare the metric to a threshold; determine a decision based at least in part on the comparison of the metric to the threshold; and transmit, to a network node, an indication of the metric and the decision.

In some implementations, a non-transitory computer-readable medium storing a set of instructions for wireless communication includes one or more instructions that, when executed by one or more processors of a network node, cause the network node to: receive, from a UE, an indication of a metric and a decision made by the UE, the metric being based at least in part on an input sample and training samples, the training samples being associated with an AI/ML model, the metric being associated with a monitoring of the AI/ML model, and the decision being based at least in part on a comparison of the metric and a threshold.

In some implementations, an apparatus for wireless communication includes means for determining a metric based at least in part on an input sample and training samples, the training samples being associated with an AI/ML model, and the metric being determined during a monitoring of the AI/ML model; means for comparing the metric to a threshold; means for determining a decision based at least in part on the comparing of the metric to the threshold; and means for transmitting, to a network node, an indication of the metric and the decision.

In some implementations, an apparatus for wireless communication includes means for receiving, from a UE, an indication of a metric and a decision made by the UE, the metric being based at least in part on an input sample and training samples, the training samples being associated with an AI/ML model, the metric being associated with a monitoring of the AI/ML model, and the decision being based at least in part on a comparison of the metric and a threshold.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of an artificial intelligence (AI) based channel state information (CSI) feedback scheme, in accordance with the present disclosure.

FIG. 5 is a diagram illustrating an example of an AI or machine learning (ML) model failure, in accordance with the present disclosure.

FIGS. 6-7 are diagrams illustrating examples associated with model monitoring using input samples, in accordance with the present disclosure.

FIGS. 8-9 are diagrams illustrating example processes associated with model monitoring using input samples, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

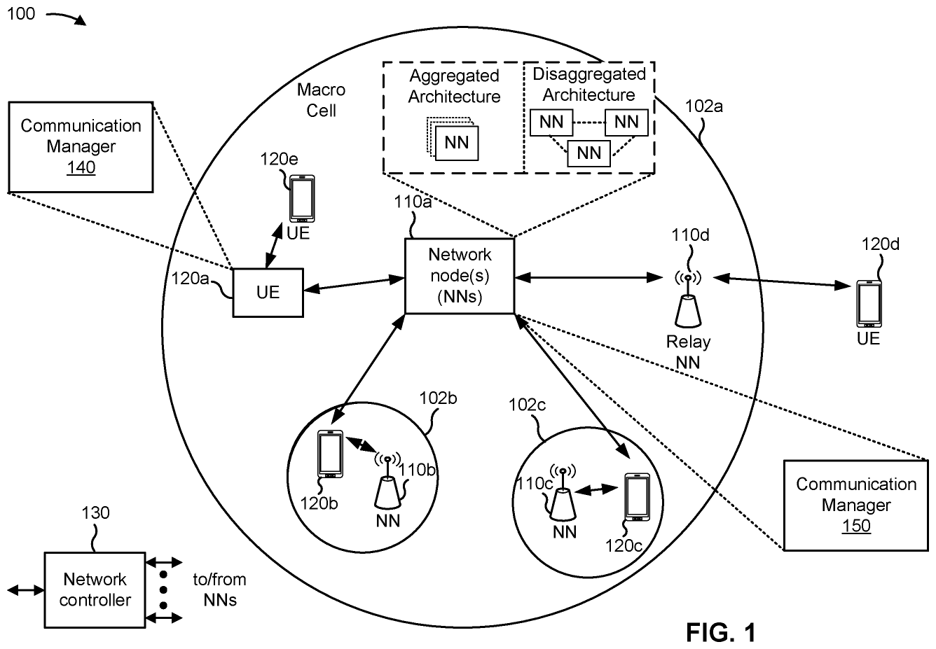

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may determine a metric based at least in part on an input sample and training samples, the training samples being associated with an artificial intelligence or machine learning (AI/ML) model, and the metric being determined during a monitoring of the AI/ML model; compare the metric to a threshold; determine a decision based at least in part on the comparison of the metric to the threshold; and transmit, to a network node, an indication of the metric and the decision. Additionally, or alternatively, the communication manager 140 may perform one or more other operations described herein.

In some aspects, a network node (e.g., network node 110) may include a communication manager 150. As described in more detail elsewhere herein, the communication manager 150 may receive, from a UE, an indication of a metric and a decision made by the UE, the metric being based at least in part on an input sample and training samples, the training samples being associated with an AI/ML model, the metric being associated with a monitoring of the AI/ML model, and the decision being based at least in part on a comparison of the metric and a threshold. Additionally, or alternatively, the communication manager 150 may perform one or more other operations described herein.

As indicated above, FIG. 1 is provided as an example. Other examples may differ from what is described with regard to FIG. 1.

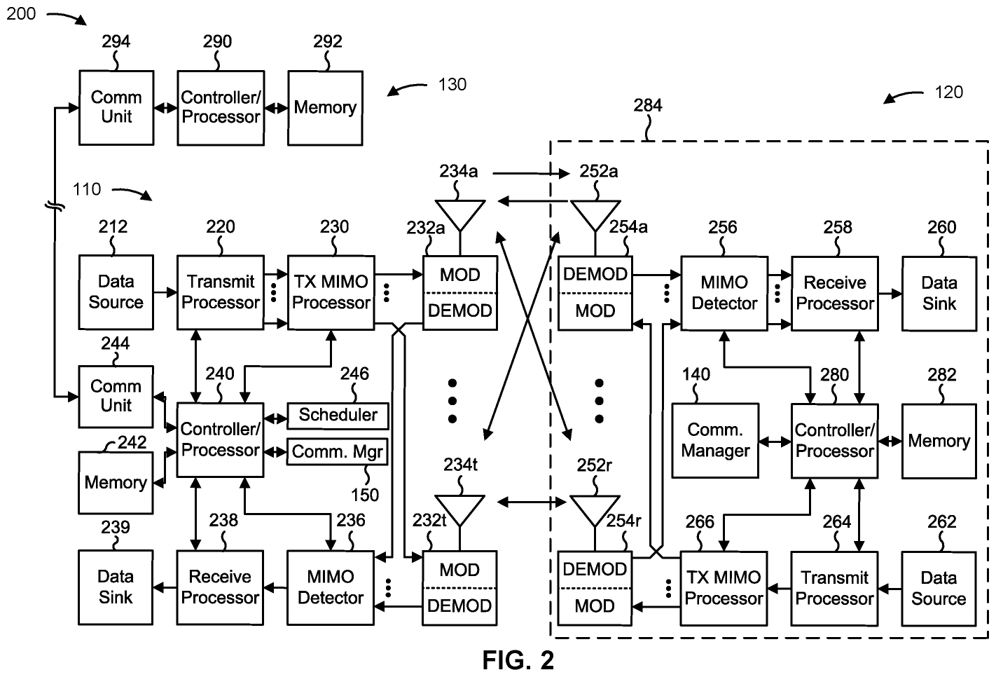

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

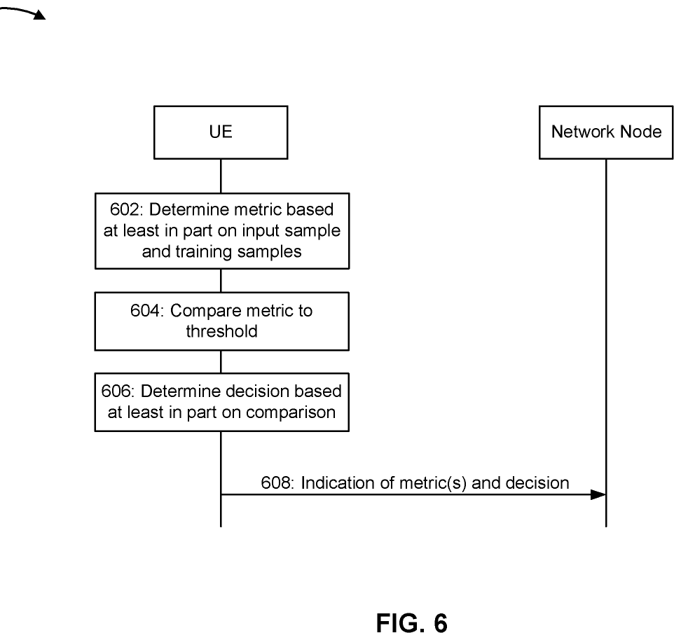

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-11).

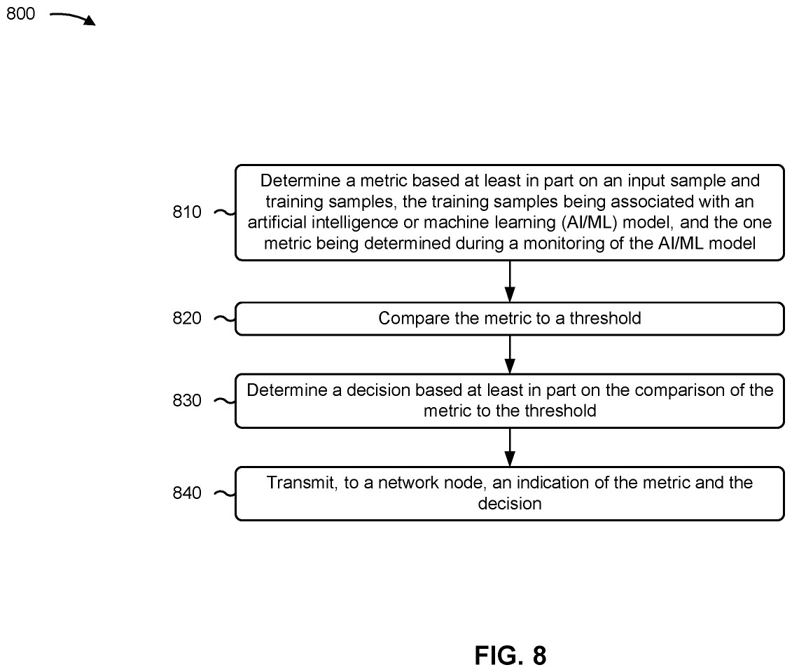

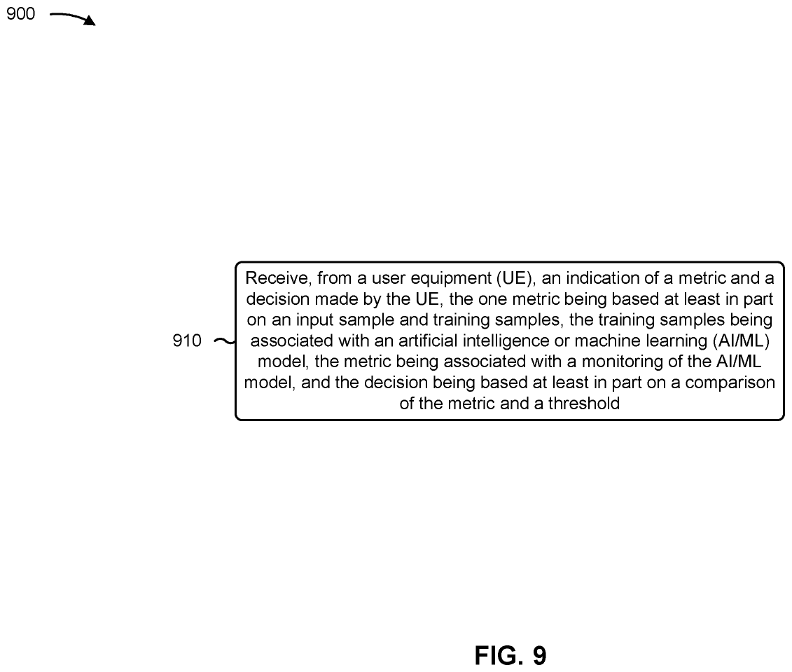

The controller/processor 240 of the network node 110, the controller/processor 280 of the UE 120, and/or any other component(s) of FIG. 2 may perform one or more techniques associated with model monitoring using input samples, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., UE 120) includes means for determining a metric based at least in part on an input sample and training samples, the training samples being associated with an AI/ML model, and the metric being determined during a monitoring of the AI/ML model; means for comparing the metric to a threshold; means for determining a decision based at least in part on the comparing of the metric to the threshold; and/or means for transmitting, to a network node, an indication of the metric and the decision. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for receiving, from a UE, an indication of a metric and a decision made by the UE, the metric being based at least in part on an input sample and training samples, the training samples being associated with an AI/ML model, the metric being associated with a monitoring of the AI/ML model, and the decision being based at least in part on a comparison of the metric and a threshold. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

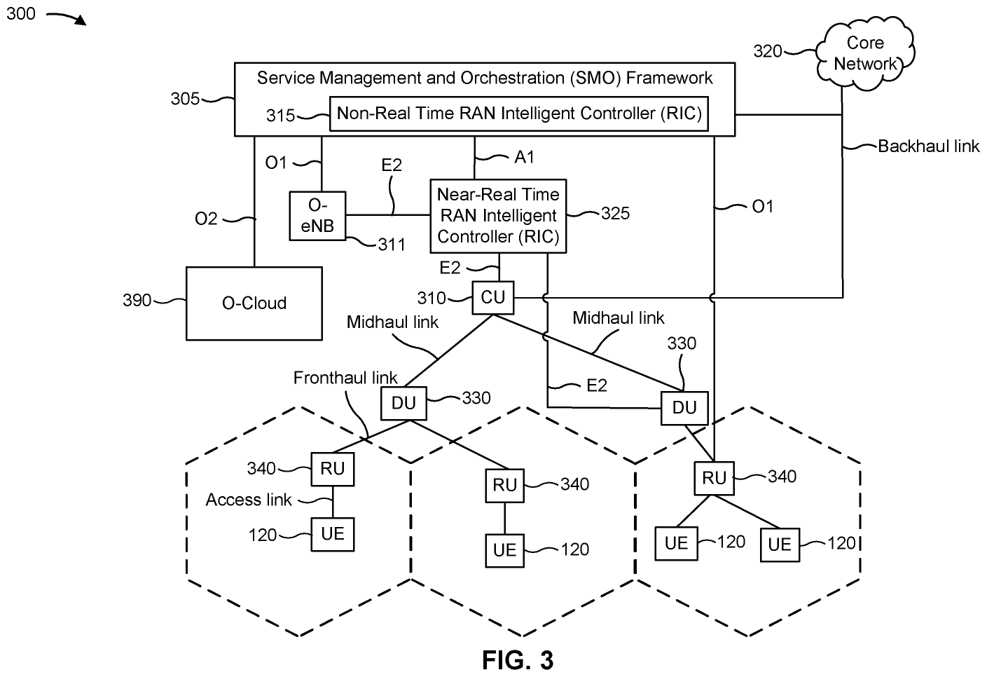

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, AI/ML workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A channel state information (CSI) report configuration may include a codebook, which may be used as a precoding matrix indicator (PMI) dictionary from which a UE may report the best PMI codewords. The UE may use a sequence of bits to report the PMI to a network node. Further, the UE may report a rank indicator (RI) and a channel quality indicator (CQI) as part of a CSI report.

An AI-based CSI feedback may replace the codebook by a CSI encoder and decoder (e.g., at least the decoder may be needed). In the AI-based CSI feedback, an encoder may be analogous to a PMI searching algorithm. A decoder may be analogous to a PMI codebook, which may be used to translate CSI reporting bits to a PMI codeword.

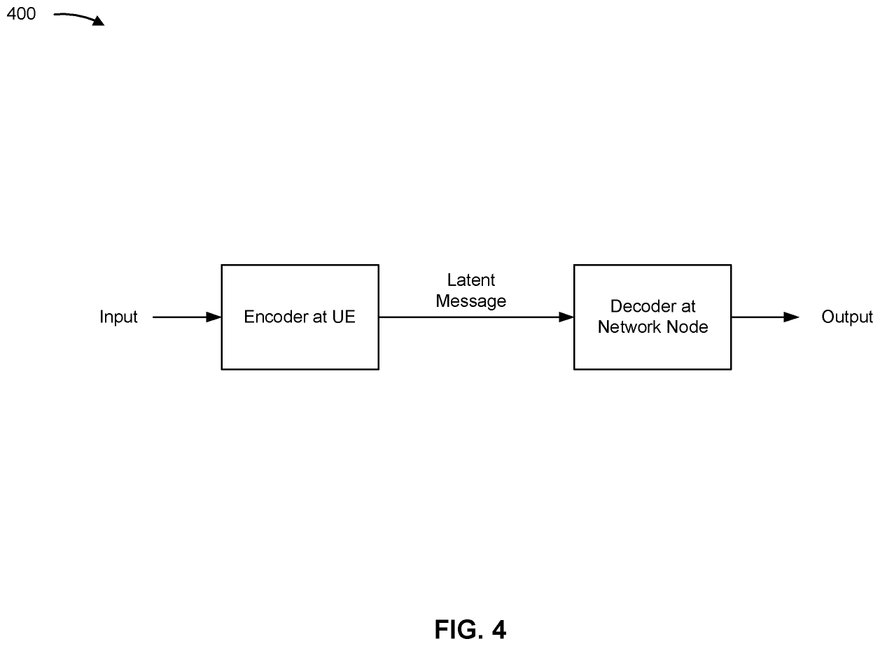

FIG. 4 is a diagram illustrating an example 400 of an AI-based CSI feedback scheme, in accordance with the present disclosure.

As shown in FIG. 4, an input may be provided to an encoder at a UE. The UE may transmit, to a network node, a latent message, which may be based at least in part on the input to the encoder. A decoder at the network node may receive the latent message. The decoder at the network node may generate an output, which may be based at least in part on the latent message. A decoder output may include a downlink channel matrix (H), a transmit covariance matrix, downlink precoders (V), an interference covariance matrix (Rnn), and/or an indication of a raw versus a whitened downlink channel. For example, for an encoder input of H, a decoder output may be H, or V, or SV, where S corresponds to an eigenvalue. For an encoder input of V, a decoder output may be V. For an encoder input of Rnn, a decoder output may be Rnn. Further, H or V may correspond to a raw channel or a channel pre-whitened by the UE based at least in part on a demodulation filter.

As indicated above, FIG. 4 is provided as an example. Other examples may differ from what is described with regard to FIG. 4.

An AI/ML model may be associated with various phases. A training phase (with synthesis data) may involve enabling an AI/ML functionality. A validation phase may involve checking whether a trained AI/ML model is functional in a real-world scenario. An inference phase may involve using the trained AI/ML model to perform a certain functionality, such as channel state feedback (CSF) and/or channel estimation. A monitoring phase may involve identifying new samples or an environment change, and whether the AI/ML model is still feasible. A model preparation (training) may differ from a model deployment. A preparation phase may be based at least in part on a pre-logged dataset, such as a channel model or a real-world data collection. A deployment phase may involve coping with real-time data from a realistic environment.

An AI/ML model mismatch may be unavoidable due to a varying wireless communication environment, and/or an uncertainty of the communication environment due to rotation/blockage. With a constrained UE capability, the AI/ML model may not be configured to match all potential variations. One type of AI/ML model mismatch may involve an out-of-distribution (OOD) or anomaly detection, which may involve a burst sample having new features, as compared to a previously logged dataset. The new features may be from an unseen distribution, or may be associated with another distribution seen during the training phase. The OOD may be detected based at least in part on an anomaly detection. Another type of AI/ML model mismatch may involve an AI/ML model failure (or distribution drift), which may involve a collection of OOD samples in a relatively short monitoring duration. The AI/ML model may not be matched with the statistics of the environment.

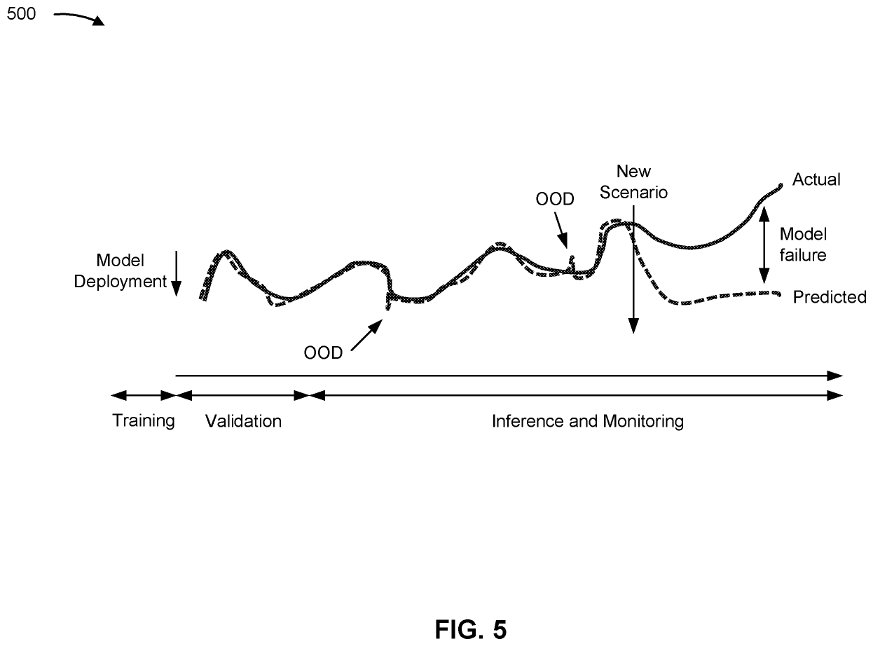

FIG. 5 is a diagram illustrating an example 500 of an AI/ML model failure, in accordance with the present disclosure.

As shown in FIG. 5, an AI/ML model may be trained during a training phase. The AI/ML model may be validated during a validation phase. The AI/ML model may be used for inference during an inference phase. The AI/ML model may be monitored during a monitoring phase. During the validation phase, the inference phase, and the monitoring phase, the AI/ML model may generate predicted results. When a predicted result differs from an actual result by a value that satisfies a threshold, an OOD may be detected. When a plurality of OOD samples are detected in a relatively short monitoring duration, the AI/ML model failure may be detected. The AI/ML model failure may result from a new scenario, which may occur after an AI/ML model deployment.

As indicated above, FIG. 5 is provided as an example. Other examples may differ from what is described with regard to FIG. 5.

A UE vendor and/or a network vendor may train specific AI/ML models for specific scenarios by clustering data. A plurality of clusters may be formed, and samples may be labeled with a nearest centroid. Each cluster may be considered as a specific distribution. A clustering may be based at least in part on the statistics of channels, such as delay spread, angle spread, doppler shift and average gain. In some cases, a clustering maybe a based on the result of performing a clustering algorithm (e.g., K-mean). By training specific AI/ML models for specific scenarios (e.g., specific clusters), a favorable performance for specific scenarios may be achieved, even with less complex AI/ML models. However, having specific AI/ML models for specific scenarios may lead to poor generalization, frequent AI/ML model switching, and/or frequent OOD.

An AI/ML model monitoring may be associated with a model activation, deactivation, selection, switching, fallback, and/or update (including re-training). “AI/ML model selection” may refer to the selection of an AI/ML model among AI/ML models for the same functionality. The AI/ML model monitoring may be part of a lifecycle management. The AI/ML model monitoring may be based at least in part on an inference accuracy, which may involve metrics related to intermediate key performance indicators (KPIs). The AI/ML model monitoring may be based at least in part on a system performance, which may involve metrics related to system performance KPIs. The AI/ML model monitoring may be based at least in part on a data distribution. In an input-based approach, a validity of an AI/ML output may be monitored, which may involve an out-of-distribution detection, a drift detection of input data, a check of a signal-to-noise ratio (SNR), and/or a check of a delay spread. In an output-based approach, a drift detection of output data may be performed. The AI/ML model monitoring may be based at least in part on an applicable condition. AI/ML model monitoring metric calculations may be performed at a network node and/or at a UE.

An AI/ML model selection, activation, deactivation, switching, and/or fallback may be based at least in part on a UE-side model or a network-side model. A decision by a network node may be based at least in part on a network-initiated monitoring, or UE-initiated monitoring and decision requested by the network node (based at least in part on the monitoring results sent by the UE). A decision by the UE may be event-triggered, as configured by the network node, and a UE decision may be reported to the network node. The decision by the UE may be UE-autonomous, and the UE decision may be reported to the network node. The decision by the UE may be UE-autonomous, and the UE decision may not be reported to the network node.

In a network-initiated approach, the network node may perform an AI/ML model monitoring and make a decision regarding an AI/ML model. In a UE-initiated and request-to-network-node approach, the UE may perform the AI/ML model monitoring and report a monitoring measurement to the network node, and the network node may make the decision. In an event-trigger or network configuration, the network node may have control of AI/ML model monitoring. In this event-triggered or network configuration approach, the UE may perform the AI/ML model monitoring, make the decision, and indicate the decision to the network node. In a UE-autonomous approach, the UE may perform the AI/ML model monitoring. The UE may make the decision, and the UE may determine whether or not to report the decision to the network node.

For AI/ML model monitoring options, the most direct KPI may be the square generalized cosine similarity (SGCS) between a ground truth (e.g., a target CSI or an input to an CSI encoder in the case the input is the target CSI) and a final CSI (e.g., the accuracy of a CSI compression/decompression). However, the UE may need to run a network-node-side decoder (for the UE to perform AI/ML model monitoring), or the UE may need to be requested to report the ground truth to the network node (for the network node to perform AI/ML model monitoring). The UE running the network-node-side decoder may increase (e.g., double) UE complexity. The UE reporting the ground truth to the network node may increase a payload, which may negate a CSI enhancement objective of decreasing a reporting overhead.

In various aspects of techniques and apparatuses described herein, a UE may determine a metric based at least in part on an input sample and training samples. The training samples may be associated with an AI/ML model. The metric may be determined during a monitoring of the AI/ML model. The UE may compare the metric to a threshold. The UE may determine a decision based at least in part on the comparison of the metric to the threshold. The decision may be associated with a switch from the AI/ML model to another AI/ML model. The decision may be associated with a deactivation of the AI/ML model. The decision may be associated with a detection of an OOD. The UE may transmit, to a network node, an indication of the metric and the decision. In some cases, especially in an UE-autonomous approach, the UE may not transmit an indication of the metric and decision to the network node.

In some aspects, the UE may perform an AI/ML model monitoring based at least in part on the input samples alone (as well as the training samples). The input samples may include a downlink channel matrix and/or downlink precoders, which may be derived from a channel state information reference signal (CSI-RS) measurement. The UE may not run a network-node-side decoder, which may avoid increasing UE complexity. Further, the UE may not report ground truth information to the network node, thereby avoiding an increase in signaling. In other words, by performing the AI/ML model monitoring based at least in part on input samples alone, additional UE complexity and/or increased signaling may be avoided for the UE.

FIG. 6 is a diagram illustrating an example 600 associated with model monitoring using input samples, in accordance with the present disclosure. As shown in FIG. 6, example 600 includes communication between a UE (e.g., UE 120) and a network node (e.g., network node 110). In some aspects, the UE and the network node may be included in a wireless network, such as wireless network 100.

As shown by reference number 602, the UE may determine a metric (or one or more metrics) based at least in part on an input sample and training samples (or training data). The metric may be based at least in part on a Euclidean distance, a squared generalized cosine similarity, or a probability assessment. The input sample may include a downlink channel matrix, a downlink precoder, or an interference covariance matrix. The training samples may be associated with an AI/ML model. The AI/ML model may run at the UE and/or at the network node. The UE may determine the metric during a monitoring of the AI/ML model.

In some aspects, the UE may determine the metric by directly using the training samples. An average distance or an average SGCS may be computed between the input sample and the training samples. In some aspects, the UE may determine the metric using an intermediate term derived using the training samples. A distance or an SGCS may be computed between the input sample and the intermediate term. In some aspects, the UE may determine the metric using a probability function derived from the training samples. A probability assessment of the input sample (e.g., an input sample in inference) may be computed using the probability function. In some aspects, the training samples may be clustered into a plurality of clusters, where a certain metric may be based at least in part on training samples associated with a corresponding cluster of the plurality of clusters.

In some aspects, the UE may calculate the metric using the input sample and the training samples. A first type of metric may be a Euclidian distance, which may be represented by ∥x−y∥², where x and y are N×1 vectors. A second type of metric may be the SGCS, which may be represented by

$$\frac{{\vert x \cdot y \vert}^{2}}{{‖ x ‖}^{2} {‖ y ‖}^{2}} ,$$

where x and y are N×1 vectors.

In some aspects, the UE may calculate the metric using the input sample (e.g., the downlink channel matrix or the downlink precoder) and the training samples. The UE may use the training samples directly. The UE may compute an average distance (e.g., Euclidean distance) or an average SGCS between the input sample and the training samples (e.g., all training data). For example, the UE may calculate the metric using the training samples directly in accordance with the following:

$$\frac{1}{N} {\sum }_{n = 0}^{N - 1} {‖ v - {v}_{n}^{t r} ‖}^{2} or$$

$$\frac{1}{N} {\sum }_{n = 0}^{N - 1} \frac{{\vert v \cdot {v}_{n}^{t r} \vert}^{2}}{{‖ v ‖}^{2} \cdot {‖ {v}_{n}^{t r} ‖}^{2}} ,$$

where v is the input sample (strongest eigenvector) and

$${v}_{n}^{t r}$$

is the n-th sample in a training sample set (or training data set). The UE may use the intermediate term derived by the training samples. The UE may compute a distance or an SGCS between the input sample and the intermediate term. For example, the UE may calculate the metric using the intermediate term derived by the training samples in accordance with the following:

$$‖ v - {v}^{t r} ‖ or$$

$$\frac{{\vert v \cdot {\overline{v}}^{t r} \vert}^{2}}{{‖ v ‖}^{2} \cdot {‖ {\overline{v}}^{t r} ‖}^{2}} ,$$

where v̅^{tr} is the intermediate term (e.g., centroid) derived by the training samples, e.g.,

$${\overline{v}}^{t r} = \frac{1}{N} {\sum }_{n = 0}^{N - 1} {v}_{n}^{t r} .$$

In some aspects, the training samples may be clustered into K clusters. The clusters may be training sample clusters (or training data clusters). The UE may determine K metrics, where a k-th metric may use training samples associated with cluster k. The UE may determine the K metrics using the training samples directly. For example, the UE may determine the K metrics using the training samples directly in accordance with the following:

$${d}_{k} = \frac{1}{{N}_{k}} {\sum }_{n = 0}^{{N}_{k} - 1} {‖ v - {v}_{k , n}^{t r} ‖}^{2} or$$

$${S}_{k} = \frac{1}{{N}_{k}} {\sum }_{n = 0}^{{N}_{k} - 1} \frac{{\vert v \cdot {v}_{k , n}^{t r} \vert}^{2}}{{‖ v ‖}^{2} \cdot {‖ {v}_{k , n}^{t r} ‖}^{2}} , ∀ k ,$$

where

$${v}_{k , n}^{t r}$$

is the n-th sample in the cluster k. The UE may determine the K metrics using the intermediate term. For example, the UE may determine the K metrics using the intermediate term in accordance with the following:

$${d}_{k} = ‖ v - {\overline{v}}_{k}^{t r} ‖ or$$

$${S}_{k} = \frac{{\vert v \cdot {\overline{v}}_{k}^{t r} \vert}^{2}}{{‖ v ‖}^{2} \cdot {‖ {\overline{v}}_{k}^{t r} ‖}^{2}} ,$$

where

$${\overline{v}}_{k}^{t r}$$

is the intermediate term (e.g., centroid) derived by the cluster k, e.g.,

$${\overline{v}}_{k}^{t r} = \frac{1}{{N}_{k}} {\sum }_{n = 0}^{{N}_{k} - 1} {v}_{k , n}^{t r} .$$

Further, the UE and/or the network node may train K models, each using the training samples of the corresponding cluster.

As shown by reference number 604, the UE may compare the metric to a threshold. Alternatively, the UE may compare one or more metrics to respective thresholds. The threshold may be one of a plurality of thresholds, which may be associated with respective clusters of the training samples. For example, thresholds may be different for different clusters. The threshold may be predefined or based at least in part on a vendor agreement. For example, the threshold may be based at least in part on an agreement between UE vendors and network node vendors. The threshold may be based at least in part on a target performance. For example, a smaller threshold for distance, or a larger threshold for SGCS, may lead to a better performance but more frequent AI/ML model switching or more frequent OOD indication. The threshold may be configured by the network node.

As shown by reference number 606, the UE may determine a decision based at least in part on the comparison of the metric to the threshold. The decision may be associated with a switch from the AI/ML model to another AI/ML model. The decision may be associated with a deactivation of the AI/ML model. The decision may be associated with a detection of an OOD, where the OOD may be based at least in part on a new sample having different features as compared to a previously logged dataset. The UE may perform a reporting of the OOD based at least in part on the detection of the OOD.

In some aspects, the training samples may be associated with a single cluster and the AI/ML model may be associated with a single AI/ML model that is trained by the training samples of the single cluster. The AI/ML model may be retained (or kept or maintained), or an OOD report may be generated, based at least in part on the metric in relation to the threshold. In some aspects, the training samples may be associated with multiple clusters and the AI/ML model may be one of multiple AI/ML models, each of which may be trained by training samples of a corresponding cluster. The AI/ML model may be retained based at least in part on the metric, for a current cluster of the multiple clusters, in relation to the threshold. An out-of-distribution report or an AI/ML model switching command may be generated based at least in part on the metric, for a closest cluster relative to a current cluster of the multiple clusters, in relation to the threshold. “Closest cluster” may refer to a cluster with a closest distance to the input sample, a cluster with a highest SGCS with the input sample, or a cluster with a highest probability assessment of the input sample, as compared to other clusters.

In some aspects, the UE may compare the metric to the threshold, and the UE may determine the decision based at least in part on the comparison of the metric to the threshold. The metric may include the distance (e.g., the Euclidean distance) or the SGCS. In other words, when determining the metric, the UE may determine the distance and/or the SGCS, which may be based at least in part on the input sample and the training samples.

In some aspects, the UE may determine the decision for a single cluster and single AI/ML model case. When the distance is less than or equal to a threshold, or when the SGCS is greater than or equal to a threshold, or when the probability assessment is greater than or equal to a threshold, the UE may continue using the current AI/ML model. In other words, the UE may stay on the current AI/ML model and not switch to another AI/ML model. When the distance is greater than the threshold, or when the SGCS is less than the threshold, or the when the probability assessment is smaller than the threshold, the UE may generate an OOD report.

In some aspects, the UE may determine the decision for a multiple cluster and multiple AI/ML model case. When a distance to a current cluster is less than or equal to a threshold, or when an SGCS to the current cluster is greater than or equal to a threshold, or when a probability assessment to the current cluster is greater than or equal to a threshold, the UE may continue using the current AI/ML model. In some aspects, the distance to the current cluster may be greater than the threshold, or the SGCS to the current cluster may be less than the threshold, or the probability assessment to the current cluster is smaller than the threshold. In this case, when a distance to a closest cluster is greater than the threshold, or an SGCS to a closest cluster is less than the threshold, or the probability assessment to the closest cluster is less than the threshold the UE may generate the OOD report. Alternatively, when the distance to the closest cluster is less than or equal to the threshold, or the SGCS to the closest cluster is greater than or equal to the threshold, or the probability assessment to the closest cluster is higher than the threshold the UE may generate the AI/ML model switching command. The AI/ML model switching command may be to switch to an AI/ML model with a cluster closest to the input sample.

In some aspects, the probability function (e.g., P(x)) may be derived from the training samples. The probability function may characterize a distribution of training samples. For an input sample x, the UE may assess whether the input sample x belongs to the distribution of training data using the probability function. When P(x) is greater than a threshold, the UE may determine that the input sample x is in-distribution. When P(x) is not greater than the threshold, the UE may detect an OOD. In some aspects, in a multiple cluster case, the UE may derive multiple Pᵢ(x). When Pᵢ(x) of a current cluster is greater than the threshold, the UE may continue using the current AI/ML model. When Pᵢ(x) of the current cluster is not greater than the threshold, the UE may determine whether a Pᵢ(x) of a closest cluster is greater than the threshold. When the Pᵢ(x) of the closest cluster is greater than the threshold, the UE may switch to the closest cluster. Otherwise, the UE may detect an OOD.

As shown by reference number 608, the UE may transmit, to the network node, an indication of the metric and the decision. The network node may determine, based at least in part on the indication, the metric, which may be based at least in part on the monitoring of the AI/ML model. In other words, the network node may be notified regarding the performance of the AI/ML model. Further, the network node may be notified regarding the decision made by the UE (e.g., AI/ML model switching, AI/ML model deactivation, or OOD detection and reporting without changing the AI/ML model).

As indicated above, FIG. 6 is provided as an example. Other examples may differ from what is described with regard to FIG. 6.

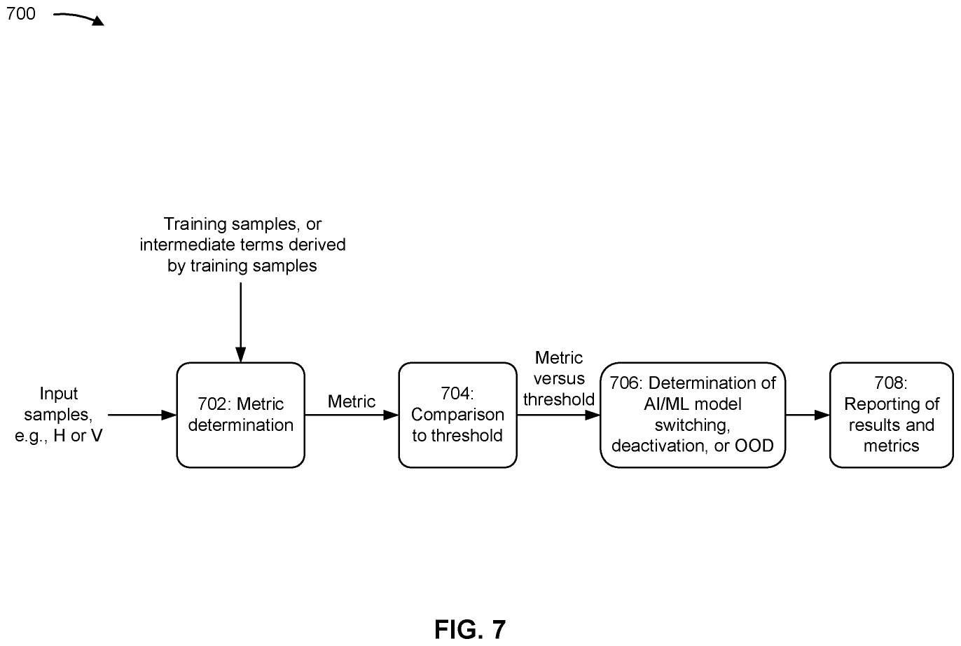

FIG. 7 is a diagram illustrating an example 700 associated with model monitoring using input samples, in accordance with the present disclosure.

As shown by reference number 702, a UE may perform a metric determination. The metric determination may be based at least in part on input samples and training samples (or intermediate terms derived from the training samples). The input samples may include a downlink channel matrix and/or downlink precoders. The training samples may be samples used to train an AI/ML model. The UE may determine a metric based at least in part on the input samples and the training samples. As shown by reference number 704, the UE may compare the metric to a threshold. The threshold may be a predefined threshold or a configured threshold. As shown by reference number 706, the UE may make a decision based at least in part on the comparison of the metric to the threshold. The decision may involve switching the AI/ML model (e.g., to another AI/ML model). The decision may involve deactivating the AI/ML model (e.g., due to an AI/ML model failure detected for the AI/ML model). The decision may involve an OOD detection, in which case the AI/ML model may continue to be used and may not change. As shown by reference number 708, the UE may report, to a network node, the decision and/or the metric. As a result, the network node may become aware of the metric captured by the UE, as well as the decision made by the UE regarding the AI/ML model.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with model monitoring using input samples.

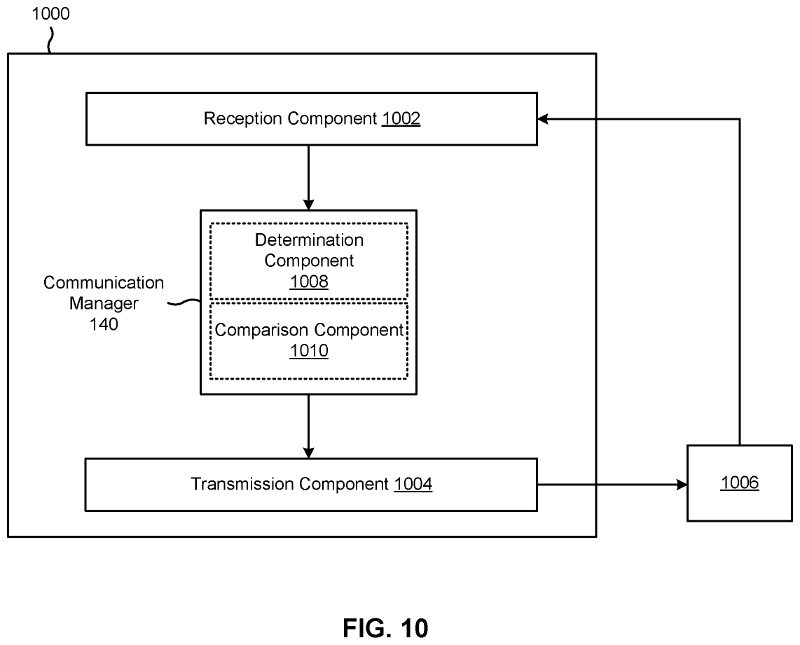

As shown in FIG. 8, in some aspects, process 800 may include determining a metric based at least in part on an input sample and training samples, the training samples being associated with an AI/ML model, and the metric being determined during a monitoring of the AI/ML model (block 810). For example, the UE (e.g., using communication manager 140 and/or determination component 1008, depicted in FIG. 10) may determine a metric based at least in part on an input sample and training samples, the training samples being associated with an AI/ML model, and the metric being determined during a monitoring of the AI/ML model, as described above in connection with FIGS. 6-7.

As further shown in FIG. 8, in some aspects, process 800 may include comparing the metric to a threshold (block 820). For example, the UE (e.g., using communication manager 140 and/or comparison component 1010, depicted in FIG. 10) may compare the metric to a threshold, as described above in connection with FIGS. 6-7.

As further shown in FIG. 8, in some aspects, process 800 may include determining a decision based at least in part on the comparing of the metric to the threshold (block 830). For example, the UE (e.g., using communication manager 140 and/or determination component 1008, depicted in FIG. 10) may determine a decision based at least in part on the comparison of the metric to the threshold, as described above in connection with FIGS. 6-7.

As further shown in FIG. 8, in some aspects, process 800 may include transmitting, to a network node, an indication of the metric and the decision (block 840). For example, the UE (e.g., using communication manager 140 and/or transmission component 1004, depicted in FIG. 10) may transmit, to a network node, an indication of the metric and the decision, as described above in connection with FIGS. 6-7.

Process 800 may include additional aspects, such as any single aspect or any combination of aspects described below and/or in connection with one or more other processes described elsewhere herein.

In a first aspect, the input sample includes a downlink channel matrix, a downlink precoder, or an interference covariance matrix, and the metric is based at least in part on a Euclidean distance, an SGCS, or a probability assessment.

In a second aspect, alone or in combination with the first aspect, the decision is associated with switching from the AI/ML model to another AI/ML model.

In a third aspect, alone or in combination with one or more of the first and second aspects, the decision is associated with deactivating the AI/ML model.

In a fourth aspect, alone or in combination with one or more of the first through third aspects, the decision is associated with detecting an OOD, and the OOD is based at least in part on a new sample having different features as compared to a previously logged dataset.

In a fifth aspect, alone or in combination with one or more of the first through fourth aspects, process 800 includes determining the metric by directly using the training samples, wherein an average distance or an average SGCS is computed between the input sample and the training samples.

In a sixth aspect, alone or in combination with one or more of the first through fifth aspects, process 800 includes determining the metric using an intermediate term derived using the training samples, wherein a distance or an SGCS is computed between the input sample and the intermediate term.

In a seventh aspect, alone or in combination with one or more of the first through sixth aspects, process 800 includes determining the metric using a probability function derived from the training samples, and a probability assessment of the input sample is computed using the probability function.

In an eighth aspect, alone or in combination with one or more of the first through seventh aspects, the training samples are clustered into a plurality of clusters, and a metric of the metric is based at least in part on training samples associated with a corresponding cluster of the plurality of clusters.

In a ninth aspect, alone or in combination with one or more of the first through eighth aspects, the training samples are associated with a single cluster and the AI/ML model is associated with a single AI/ML model that is trained by the training samples of the single cluster, and the AI/ML model is retained or an out-of-distribution report is generated based at least in part on the metric in relation to the threshold.

In a tenth aspect, alone or in combination with one or more of the first through ninth aspects, the training samples are associated with multiple clusters and the AI/ML model is one of multiple AI/ML models, each of which is trained by training samples of a corresponding cluster.

In an eleventh aspect, alone or in combination with one or more of the first through tenth aspects, the AI/ML model is retained based at least in part on the metric, for a current cluster of the multiple clusters, in relation to the threshold.

In a twelfth aspect, alone or in combination with one or more of the first through eleventh aspects, an OOD report or an AI/ML model switching command is generated based at least in part on the metric, for a closest cluster relative to a current cluster of the multiple clusters, in relation to the threshold.

In a thirteenth aspect, alone or in combination with one or more of the first through twelfth aspects, the threshold is one of a plurality of thresholds associated with respective clusters of the training samples, the threshold is predefined or based at least in part on a vendor agreement, the threshold is based at least in part on a target performance, or the threshold is configured by the network node.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with model monitoring using input samples.

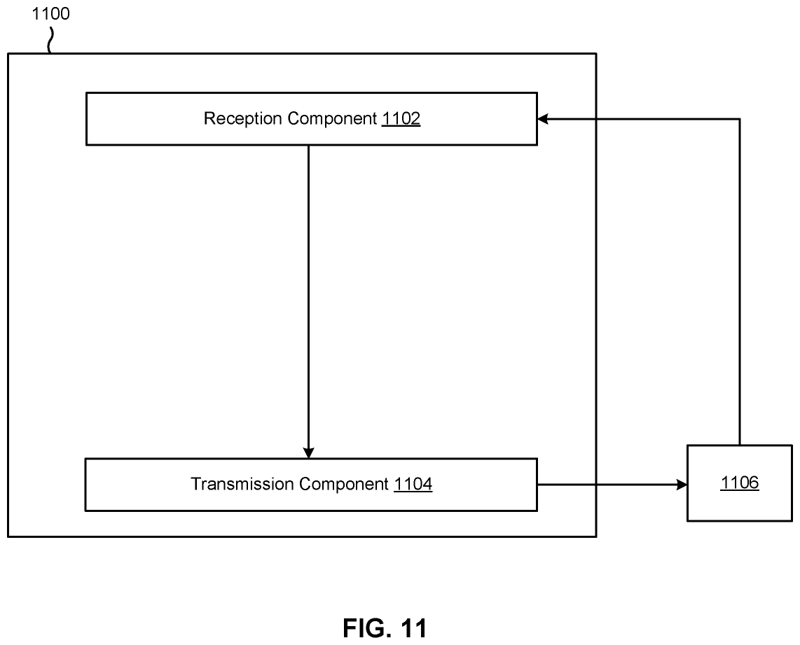

As shown in FIG. 9, in some aspects, process 900 may include receiving, from a UE, an indication of a metric and a decision made by the UE, the metric being based at least in part on an input sample and training samples, the training samples being associated with an AI/ML model, the metric being associated with a monitoring of the AI/ML model, and the decision being based at least in part on a comparison of the metric and a threshold (block 910). For example, the network node (e.g., using reception component 1102, depicted in FIG. 11) may receive, from a UE, an indication of a metric and a decision made by the UE, the metric being based at least in part on an input sample and training samples, the training samples being associated with an AI/ML model, the metric being associated with a monitoring of the AI/ML model, and the decision being based at least in part on a comparison of the metric and a threshold, as described above in connection with FIGS. 6-7.

Process 900 may include additional aspects, such as any single aspect or any combination of aspects described below and/or in connection with one or more other processes described elsewhere herein.

In a first aspect, the input sample includes a downlink channel matrix, a downlink precoder, or an interference covariance matrix, and the metric is based at least in part on a Euclidean distance, an SGCS, or a probability assessment.

In a second aspect, alone or in combination with the first aspect, the decision is associated with switching from the AI/ML model to another AI/ML model.

In a third aspect, alone or in combination with one or more of the first and second aspects, the decision is associated with deactivating the AI/ML model.

In a fourth aspect, alone or in combination with one or more of the first through third aspects, the decision is associated with detecting an OOD, and the OOD is based at least in part on a new sample having different features as compared to a previously logged dataset.

In a fifth aspect, alone or in combination with one or more of the first through fourth aspects, the metric is determined by directly using the training samples, wherein an average distance or an average SGCS is computed between the input sample and the training samples.

In a sixth aspect, alone or in combination with one or more of the first through fifth aspects, the metric is determined using an intermediate term derived using the training samples, wherein a distance or an SGCS is computed between the input sample and the intermediate term.

In a seventh aspect, alone or in combination with one or more of the first through sixth aspects, the metric is determined using a probability function derived from the training samples, and a probability assessment of the input sample is computed using the probability function.

In an eighth aspect, alone or in combination with one or more of the first through seventh aspects, the training samples are clustered into a plurality of clusters, and a metric of the metric is based at least in part on training samples associated with a corresponding cluster of the plurality of clusters.

In a ninth aspect, alone or in combination with one or more of the first through eighth aspects, the training samples are associated with a single cluster and the AI/ML model is associated with a single AI/ML model that is trained by the training samples of the single cluster, and the AI/ML model is retained or an out-of-distribution report is generated based at least in part on the metric in relation to the threshold.

In a tenth aspect, alone or in combination with one or more of the first through ninth aspects, the training samples are associated with multiple clusters and the AI/ML model is one of multiple AI/ML models, each of which is trained by training samples of a corresponding cluster.

In an eleventh aspect, alone or in combination with one or more of the first through tenth aspects, the AI/ML model is retained based at least in part on the metric, for a current cluster of the multiple clusters, in relation to the threshold.

In a twelfth aspect, alone or in combination with one or more of the first through eleventh aspects, an OOD report or an AI/ML model switching command is generated based at least in part on the metric, for a closest cluster relative to a current cluster of the multiple clusters, in relation to the threshold.

In a thirteenth aspect, alone or in combination with one or more of the first through twelfth aspects, the threshold is one of a plurality of thresholds associated with respective clusters of the training samples, the threshold is predefined or based at least in part on a vendor agreement, the threshold is based at least in part on a target performance, or the threshold is configured by the network node.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a determination component 1008, or a comparison component 1010, among other examples.

In some aspects, the apparatus 1000 may be configured to perform one or more operations described herein in connection with FIGS. 6-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The determination component 1008 may determine a metric based at least in part on an input sample and training samples, the training samples being associated with an AI/ML model, and the metric being determined during a monitoring of the AI/ML model. The comparison component 1010 may compare the metric to a threshold. The determination component 1008 may determine a decision based at least in part on the comparison of the metric to the threshold. The transmission component 1004 may transmit, to a network node, an indication of the metric and the decision.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104.

In some aspects, the apparatus 1100 may be configured to perform one or more operations described herein in connection with FIGS. 6-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The reception component 1102 may receive, from a UE, an indication of a metric and a decision made by the UE, the metric being based at least in part on an input sample and training samples, the training samples being associated with an AI/ML model, the metric being associated with a monitoring of the AI/ML model, and the decision being based at least in part on a comparison of the metric and a threshold.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: determining a metric based at least in part on an input sample and training samples, the training samples being associated with an artificial intelligence or machine learning (AI/ML) model, and the metric being determined during a monitoring of the AI/ML model; comparing the metric to a threshold; determining a decision based at least in part on the comparing of the metric to the threshold; and transmitting, to a network node, an indication of the metric and the decision.
Aspect 2: The method of Aspect 1, wherein the input sample includes a downlink channel matrix, a downlink precoder, or an interference covariance matrix, and wherein the metric is based at least in part on a Euclidean distance, a squared generalized cosine similarity, or a probability assessment.
Aspect 3: The method of any of Aspects 1-2, wherein the decision is associated with switching from the AI/ML model to another AI/ML model.
Aspect 4: The method of any of Aspects 1-3, wherein the decision is associated with deactivating the AI/ML model.
Aspect 5: The method of any of Aspects 1-4, wherein the decision is associated with detecting an out-of-distribution (OOD), and wherein the OOD is based at least in part on a new sample having different features as compared to a previously logged dataset.
Aspect 6: The method of any of Aspects 1-5, wherein determining the metric further comprises determining the metric by directly using the training samples, wherein an average distance or an average squared generalized cosine similarity is computed between the input sample and the training samples.
Aspect 7: The method of any of Aspects 1-6, wherein determining the metric further comprises determining the metric using an intermediate term derived using the training samples, wherein a distance or a squared generalized cosine similarity is computed between the input sample and the intermediate term.
Aspect 8: The method of any of Aspects 1-7, wherein determining the metric further comprises determining the metric using a probability function derived from the training samples, and wherein a probability assessment of the input sample is computed using the probability function.
Aspect 9: The method of any of Aspects 1-8, wherein the training samples are clustered into a plurality of clusters, and wherein a metric of the metric is based at least in part on training samples associated with a corresponding cluster of the plurality of clusters.
Aspect 10: The method of any of Aspects 1-9, wherein the training samples are associated with a single cluster and the AI/ML model is associated with a single AI/ML model that is trained by the training samples of the single cluster, and wherein the AI/ML model is retained or an out-of-distribution report is generated based at least in part on the metric in relation to the threshold.
Aspect 11: The method of any of Aspects 1-10, wherein the training samples are associated with multiple clusters and the AI/ML model is one of multiple AI/ML models, each of which is trained by training samples of a corresponding cluster.
Aspect 12: The method of Aspect 11, wherein the AI/ML model is retained based at least in part on the metric, for a current cluster of the multiple clusters, in relation to the threshold.
Aspect 13: The method of Aspect 11, wherein an out-of-distribution report or an AI/ML model switching command is generated based at least in part on the metric, for a closest cluster relative to a current cluster of the multiple clusters, in relation to the threshold.
Aspect 14: The method of any of Aspects 1-13, wherein the threshold is one of a plurality of thresholds associated with respective clusters of the training samples, the threshold is predefined or based at least in part on a vendor agreement, the threshold is based at least in part on a target performance, or the threshold is configured by the network node.
Aspect 15: A method of wireless communication performed by a network node, comprising: receiving, from a user equipment (UE), an indication of a metric and a decision made by the UE, the metric being based at least in part on an input sample and training samples, the training samples being associated with an artificial intelligence or machine learning (AI/ML) model, the metric being associated with a monitoring of the AI/ML model, and the decision being based at least in part on a comparison of the metric and a threshold.
Aspect 16: An apparatus for wireless communication at a device, comprising a processor; memory coupled with the processor; and instructions stored in the memory and executable by the processor to cause the apparatus to perform the method of one or more of Aspects 1-14.
Aspect 17: A device for wireless communication, comprising a memory and one or more processors coupled to the memory, the one or more processors configured to perform the method of one or more of Aspects 1-14.
Aspect 18: An apparatus for wireless communication, comprising at least one means for performing the method of one or more of Aspects 1-14.
Aspect 19: A non-transitory computer-readable medium storing code for wireless communication, the code comprising instructions executable by a processor to perform the method of one or more of Aspects 1-14.
Aspect 20: A non-transitory computer-readable medium storing a set of instructions for wireless communication, the set of instructions comprising one or more instructions that, when executed by one or more processors of a device, cause the device to perform the method of one or more of Aspects 1-14.
Aspect 21: An apparatus for wireless communication at a device, comprising a processor; memory coupled with the processor; and instructions stored in the memory and executable by the processor to cause the apparatus to perform the method of Aspect 15.
Aspect 22: A device for wireless communication, comprising a memory and one or more processors coupled to the memory, the one or more processors configured to perform the method of Aspect 15.
Aspect 23: An apparatus for wireless communication, comprising at least one means for performing the method of Aspect 15.
Aspect 24: A non-transitory computer-readable medium storing code for wireless communication, the code comprising instructions executable by a processor to perform the method of Aspect 15.
Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
determine a metric based at least in part on an input sample and training samples, the training samples being associated with an artificial intelligence or machine learning (AI/ML) model, and the metric being determined during a monitoring of the AI/ML model;
compare the metric to a threshold;
determine a decision based at least in part on the comparison of the metric to the threshold; and
transmit, to a network node, an indication of the metric and the decision.

2. The apparatus of claim 1, wherein the input sample includes a downlink channel matrix, a downlink precoder, or an interference covariance matrix, and wherein the metric is based at least in part on a Euclidean distance, a squared generalized cosine similarity, or a probability assessment.

3. The apparatus of claim 1, wherein the decision is associated with a switch from the AI/ML model to another AI/ML model.

4. The apparatus of claim 1, wherein the decision is associated with a deactivation of the AI/ML model.

5. The apparatus of claim 1, wherein the decision is associated with a detection of an out-of-distribution (OOD), and wherein the OOD is based at least in part on a new sample having different features as compared to a previously logged dataset.

6. The apparatus of claim 1, wherein the one or more processors are further configured to determine the metric by directly using the training samples, and wherein an average distance or an average squared generalized cosine similarity is computed between the input sample and the training samples.

7. The apparatus of claim 1, wherein the one or more processors are further configured to determine the metric using an intermediate term derived using the training samples, and wherein a distance or a squared generalized cosine similarity is computed between the input sample and the intermediate term.

8. The apparatus of claim 1, wherein the one or more processors are further configured to determine the metric using a probability function derived from the training samples, and wherein a probability assessment of the input sample is computed using the probability function.

9. The apparatus of claim 1, wherein the training samples are clustered into a plurality of clusters, and wherein a metric of the metric is based at least in part on training samples associated with a corresponding cluster of the plurality of clusters.

10. The apparatus of claim 1, wherein the training samples are associated with a single cluster and the AI/ML model is associated with a single AI/ML model that is trained by the training samples of the single cluster, and wherein the AI/ML model is retained or an out-of-distribution report is generated based at least in part on the metric in relation to the threshold.

11. The apparatus of claim 1, wherein the training samples are associated with multiple clusters and the AI/ML model is one of multiple AI/ML models, each of which is trained by training samples of a corresponding cluster.

12. The apparatus of claim 11, wherein the AI/ML model is retained based at least in part on the metric, for a current cluster of the multiple clusters, in relation to the threshold.

13. The apparatus of claim 11, wherein an out-of-distribution report or an AI/ML model switching command is generated based at least in part on the metric, for a closest cluster relative to a current cluster of the multiple clusters, in relation to the threshold.

14. The apparatus of claim 1, wherein the threshold is one of a plurality of thresholds associated with respective clusters of the training samples, the threshold is predefined or based at least in part on a vendor agreement, the threshold is based at least in part on a target performance, or the threshold is configured by the network node.

15. An apparatus for wireless communication at a network node, comprising:
a memory; and
one or more processors, coupled to the memory, configured to:
receive, from a user equipment (UE), an indication of a metric and a decision made by the UE, the metric being based at least in part on an input sample and training samples, the training samples being associated with an artificial intelligence or machine learning (AI/ML) model, the metric being associated with a monitoring of the AI/ML model, and the decision being based at least in part on a comparison of the metric and a threshold.

16. A method of wireless communication performed by a user equipment (UE), comprising:
determining a metric based at least in part on an input sample and training samples, the training samples being associated with an artificial intelligence or machine learning (AI/ML) model, and the metric being determined during a monitoring of the AI/ML model;
comparing the metric to a threshold;
determining a decision based at least in part on the comparing of the metric to the threshold; and
transmitting, to a network node, an indication of the metric and the decision.

17. The method of claim 16, wherein the input sample includes a downlink channel matrix, a downlink precoder, or an interference covariance matrix, and wherein the metric is based at least in part on a Euclidean distance, a squared generalized cosine similarity, or a probability assessment.

18. The method of claim 16, wherein the decision is associated with switching from the AI/ML model to another AI/ML model.

19. The method of claim 16, wherein the decision is associated with deactivating the AI/ML model.

20. The method of claim 16, wherein the decision is associated with detecting an out-of-distribution (OOD), and wherein the OOD is based at least in part on a new sample having different features as compared to a previously logged dataset.

21.-30. (canceled)
